(19) United States
(12) Patent Application Publication
(10) Pub. No.: US 2007/0262921 A1
(43) Pub. Date: Nov. 15, 2007

(54) Plasma Display Panel Drive Method and Plasma Display Device

(76) Inventors: Yoshimasa Horie, Osaka (JP); Minoru Takeda, Osaka (JP)

Correspondence Address: WENDEROTH, LIND & PONACK L.L.P., 2033 K. STREET, NW, SUITE 800, WASHINGTON, DC, 20006, US

(21) Appl. No.: 11/660,644

(22) PCT Filed: Apr. 13, 2006
(86) PCT No.: PCT/JP06/07816

§ 371 Date: Feb. 21, 2007

(30) Foreign Application Priority Data
Apr. 13, 2005 (JP) 2005-115302

(51) Int. Cl. G09G 3/28

(52) U.S. Cl. 345/60

(57) ABSTRACT

One field period includes at least one subfield (SF) group made of at least two successive SFs. In the SF group, in the SF subsequent to a SF in which no sustaining discharge is caused, writing discharge is controlled to cause no sustaining discharge. One of all-cell initializing operation and selective initializing operation to be performed in the initializing period in the top SF of the SF group is determined depending on a signal of an image to be displayed. In the top SF of the SF group, the period allocated to the writing discharge in the case of the selective initializing operation is set longer than the period allocated to the writing discharge in the case of the all-cell initializing operation. This structure provides a plasma display panel and a driving method thereof capable of inhibiting increases in black picture level and displaying images at excellent quality.

### TECHNICAL FIELD

The present invention relates to a method of driving a plasma display panel, and a plasma display device using the method.

### BACKGROUND ART

An alternating-current surface-discharging panel representative of plasma display panels (hereinafter abbreviated as “panels”) has a large number of discharge cells formed between a front panel and rear panel thereof faced with each other. In the front panel, a plurality of display electrodes, each made of a pair of scan electrode and sustain electrode, are formed on a front glass substrate in parallel with each other. A dielectric layer and a protective layer are formed to cover these display electrodes. In the rear panel, a plurality of parallel data electrodes are formed on a rear glass substrate and a dielectric layer is formed over the data electrodes to cover them. Further, a plurality of barrier ribs are formed on the dielectric layer in parallel with the data electrodes. Phosphor layers are formed on the surface of the dielectric layer and the side faces of the barrier ribs. Then, the front panel and the rear panel are faced with each other and sealed together so that the display electrodes and data electrodes intersect with each other. A discharge gas is filled into an inside discharge space formed between the panels. Discharge cells are formed in portions where the respective display electrodes are opposed to the corresponding data electrodes. In a panel structured as above, gas discharge generates ultraviolet light in each discharge cell. This ultraviolet light excites the phosphors of red, green, and blue to emit the respective colors for color display.

A general method of driving a panel is a subfield method: one field period is divided into a plurality of subfields and combination of light-emitting subfields provides gradation display. Among the subfield methods, a novel driving method of minimizing the light emission unrelated to gradation display to inhibit increases in black picture level and improve a contrast ratio is disclosed in Japanese Patent Unexamined Publication No. 2000-242224.

The method disclosed in Japanese Patent Unexamined Publication No. 2000-242224 is briefly described hereinafter. Each subfield has an initializing period, writing period, and sustaining period. In the initializing period, one of all-cell initializing operation and selective initializing operation is performed. The all-cell initializing operation causes initializing discharge in all the discharge cells used to display an image. The selective discharge operation selectively causes initializing discharge in the discharge cells having generated sustaining discharge in the preceding subfield.

In the all-cell initializing period, initializing discharge operation is caused in all the discharge cells at a time, to erase the history of wall electric charge previously formed in the respective discharge cells and form wall electric charge necessary for the subsequent writing operation. Additionally, this initializing discharge operation serves to generate priming (priming for discharge=excited particles) for reducing discharge delay and causing stable writing discharge. In the selective initializing period, wall charge necessary for writing operation is formed in the discharge cells having generated sustaining discharge in the preceding subfield. In the subsequent writing period, scan pulses are sequentially applied to the scan electrodes, and write pulses corresponding to the signals of an image to be displayed are applied to the data electrodes. Thus, selective writing discharge is caused between the scan electrodes and corresponding data electrodes to selectively form wall charge. In the sustaining period, a predetermined number of sustain pulses according to the brightness weight is applied between the scan electrodes and corresponding sustain electrodes to cause selective discharge for light emission in the discharge cells in which writing discharge has formed wall charge. Then, reducing the number of subfields in which the all-cell initializing occurs can decrease the light emission unrelated to gradations, thus inhibiting increases in black picture level.

To properly display an image, securely performing the selective writing discharge in the writing period is important. However, there are many factors in increasing discharge delay during writing discharge, such as restrictions on circuitry prohibiting the use of high voltage for a write pulse, and phosphor layers formed on the data electrodes hindering occurrence of discharge. For this reason, the priming for causing stable writing discharge is extremely important.

Recently, active considerations have been given to the structures or materials of the panel so that the panel can meet the requirements for reduction in power consumption and increases in brightness. For example, it is generally known that increasing the partial pressure of xenon in the discharge gas filled into the panel improves the luminous efficiency of the panel. However, for the above panel and method of driving the panel, increases in the partial pressure of xenon destabilizes writing discharge. This unstable discharge poses a problem of writing failures in the writing period that are caused by a narrower margin of the driving voltage in the wiring operation.

### SUMMARY OF THE INVENTION

The present invention aims to address these problems, and provides a panel driving method and a plasma display device in which stabilizing writing discharge inhibits increases in black picture level and allows images to be displayed at high quality.

The present invention includes a plurality of subfields (SFs), each including an initializing period for generating initializing discharge in discharge cells, a writing period for generating writing discharge in the discharge cells, and a sustaining period for generating sustaining discharge to cause the discharge cells having generated the writing discharge to emit light at a predetermined brightness weight. One field period includes at least one SF group made of at least two successive SFs. In the SF group, in a SF subsequent to a SF in which no sustaining discharge occurs, writing discharge is controlled to cause no sustaining discharge. The initializing discharge includes all-cell initializing operation for causing the initializing discharge in all the discharge cells used to display an image, and selective initializing operation for causing initializing discharge in all the discharge cells having generated sustaining discharge in the preceding SF. In the top SF of the SF group, the period allocated to the writing discharge when the selective initializing operation is caused in the initializing period is set longer than the period allocated to the writing discharge when the all-cell initializing operation is caused in the initializing period. Each of the discharge cells is formed at an intersection of scan and sustain electrodes and a data electrode. An aspect of the present invention provides a panel driving method comprising: determining to cause one of the all-cell initializing operation and selective initializing operation in the initializing period in the top SF of the SF group according to a signal of an image to be displayed.

This method can stabilize the writing discharge and provide a panel driving method capable of inhibiting increases in black picture level and displaying images at high quality.

Another aspect of the present invention provides a panel driving method, wherein the determining the initializing operation in the initializing period in the top SF of the SF group can be performed according to a light-emitting rate of a predetermined SF with respect to the signal of the image to be displayed. This method can also provide a panel driving method capable of inhibiting increases in black picture level and displaying images at high quality.

Still another aspect of the present invention provides a panel driving method, wherein the determining the initializing operation in the initializing period in each of the SFs other than those in the SF group can be performed according to an average picture level (APL) of the signal of the image to be displayed. This method can provide an image having high contrast because the area displaying black picture has low brightness at a low APL.

Yet another aspect of the present invention provides a plasma display device using the above panel driving method. This structure can stabilize the writing discharge and provide a plasma display device capable of inhibiting increases in black picture level and displaying images at high quality.

The present invention can provide a panel driving method and a plasma display device in which stabilizing the writing discharge inhibits increases in black picture level and allows images to be displayed at high quality.

### BRIEF DESCRIPTION OF THE DRAWINGS

FIG. 1 is a perspective view illustrating an essential part of a panel for use in a first exemplary embodiment of the present invention.

FIG. 2 is a diagram illustrating an array of electrodes of the panel for use in the first exemplary embodiment.

FIG. 3 is a circuit block diagram showing a structure of a plasma display device in accordance with the first exemplary embodiment.

FIG. 4 is a diagram showing driving waveforms to be applied to the respective electrodes of the panel for use in the first exemplary embodiment.

FIG. 5 is a table showing coding in accordance with the first exemplary embodiment of the present invention.

FIG. 6A is a diagram illustrating a structure of subfields in accordance with the first exemplary embodiment.

FIG. 6B is a diagram illustrating a structure of subfields in accordance with the first exemplary embodiment.

FIG. 6C is a diagram illustrating a structure of subfields in accordance with the first exemplary embodiment.

FIG. 7 is a table showing writing periods in accordance with the first exemplary embodiment.

FIG. 8A is a diagram illustrating a structure of subfields in accordance with a second exemplary embodiment.

FIG. 8B is a diagram illustrating a structure of subfields in accordance with the second exemplary embodiment.

FIG. 8C is a diagram illustrating a structure of subfields in accordance with the second exemplary embodiment.

FIG. 9 is a table showing writing periods in accordance with the second exemplary embodiment.

### REFERENCE MARKS IN THE DRAWINGS

1 Panel
2 Front substrate
3 Rear substrate
4 Scan electrode
5 Sustain electrode
9 Data electrode
12 Data electrodes driver circuit
13 Scan electrodes driver circuit
14 Sustain electrodes driver circuit
15 Timing-generating circuit
18 Analog/digital (AD) converter
19 Line number converter
20 Subfield converter
30 APL detector
40 Light-emitting rate calculator

### DETAILED DESCRIPTION OF PREFERRED EMBODIMENTS

Hereinafter, a description is provided of a panel driving method in accordance with exemplary embodiments, with reference to the accompanying drawings.

### First Exemplary Embodiment

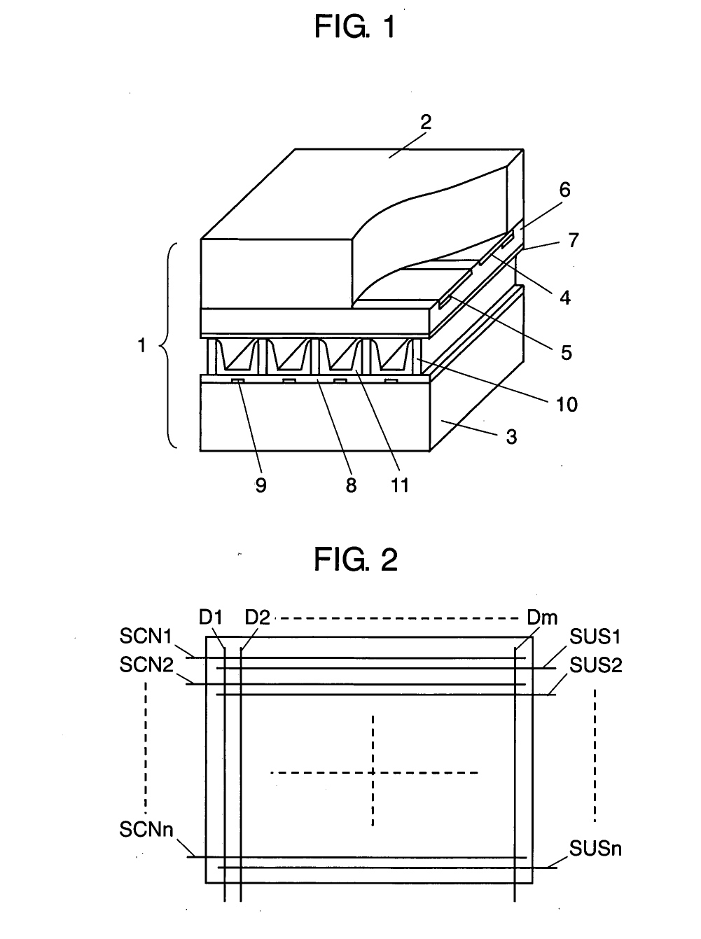

FIG. 1 is a perspective view illustrating an essential part of a panel for use in the first exemplary embodiment of the present invention. Panel 1 is composed of front substrate 2 and rear substrate 3 that are made of glass and faced with each other so as to form a discharge space therebetween. On front substrate 2, a plurality of display electrodes, each formed of a pair of scan electrode 4 and sustain electrode 5, are formed in parallel with each other. Dielectric layer 6 is formed to cover scan electrodes 4 and sustain electrodes 5. Over dielectric layer 6, protective layer 7 is formed. On rear substrate 3, a plurality of data electrodes 9 covered with insulating layer 8 are provided. Barrier ribs 10 are provided on insulating layer 8 between data electrodes 9 in parallel therewith. Also, phosphor layers 11 are provided on the surface of insulating layer 8 and the side faces of barrier ribs 10. Front substrate 2 and rear substrate 3 are faced with each other in a direction in which scan electrodes 4 and sustain electrodes 5 intersect data electrodes 9. In a discharge space formed between the substrates, a mixed gas, e.g. neon-xenon, is filled as a discharge gas.

FIG. 2 is a diagram showing an array of electrodes of the panel for use in the first exemplary embodiment of the present invention. N scan electrodes SCN 1 to SCNn (scan electrodes 4 in FIG. 1) and n sustain electrodes SUS 1 to SUSn (sustain electrodes 5 in FIG. 1) are alternately disposed in a row direction. M data electrodes D1 to Dm (data electrodes 9 in FIG. 1) are disposed in a column direction. A discharge cell is formed in a portion in which a pair of scan electrode SCNi and sustain electrode SUSi (i=1 to n) intersect one data electrode Dj (j=1 to m). Thus, m×n discharge cells are formed in the discharge space.

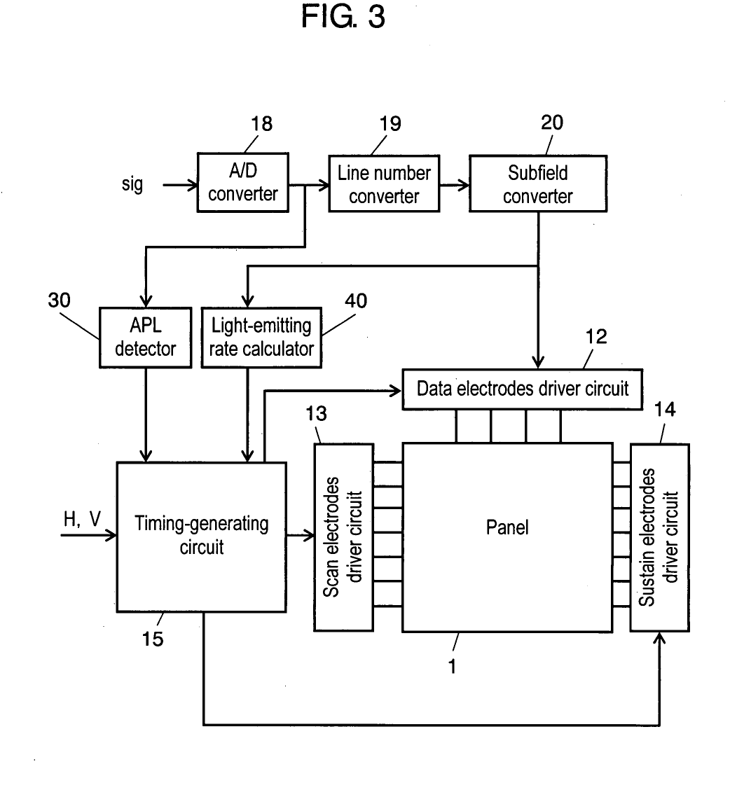

FIG. 3 is a circuit block diagram of a plasma display device in accordance with the first exemplary embodiment. The plasma display device includes panel 1, data electrodes driver circuit 12, scan electrodes driver circuit 13, sustain electrodes driver circuit 14, timing-generating circuit 15, analog-to-digital (A/D) converter 18, line number converter 19, subfield converter 20, average picture level (APL) detector 30, light-emitting rate calculator 40, and power supply circuits (not shown).

With reference to FIG. 3, image signal sig is fed into A/D converter 18. Horizontal synchronizing signal H and vertical synchronizing signal V are fed into timing-generating circuit 15. A/D converter 18 converts image signal sig into image data of digital signals, and feeds the image data into line number converter 19 and APL detector 30. APL detector 30 detects the average picture level of the image data. Line number converter 19 converts the image data into image data corresponding to the number of pixels of panel 1, and feeds the image data to subfield converter 20. Subfield converter 20 divides the image data of the respective pixels into a plurality of bits corresponding to a plurality of subfields. The image data per subfield is fed into data electrodes driver circuit 12 and light-emitting rate calculator 40. Light-emitting rate calculator 40 calculates the light-emitting rate of the SF, i.e. the rate of the discharge cells causing sustaining discharge, based on the image data per SF. Data electrodes driver circuit 12 converts the image data per SF into signals corresponding to respective data electrodes D1 to Dm, and drives the respective data electrodes.

Timing-generating circuit 15 generates various kinds of timing signals based on horizontal synchronizing signal H and vertical synchronizing signal V, and feeds the timing signals to each circuit block. Responsive to the timing signals, scan electrodes driver circuit 13 feeds driving waveforms to scan electrodes SCN1 to SCNn. Responsive to the timing signals, sustain electrodes driver circuit 14 feeds driving waveforms to sustain electrodes SUS1 to SUSn. At this time, timing-generating circuit 15 controls the driving waveforms, according to an APL supplied from APL detector 30 and a light-emitting rate signal supplied from light-emitting rate calculator 40. Specifically, as described later, according to the APL and light-emitting rate signal, timing-generating circuit 15 determines to cause one of all-cell initializing operation and selective initializing operation in each of the subfields comprising one field, and controls the number of the all-cell initializing operations in one field and the period allocated to writing discharge per cell (hereinafter abbreviated as “writing period”).

Next, a method of driving the panel is described. In the first exemplary embodiment, one field is divided into 12 subfields (SF1 to SF12), and each of the subfields has a brightness weight of 1, 2, 3, 6, 11, 18, 28, 32, 34, 37, 40 or 44.

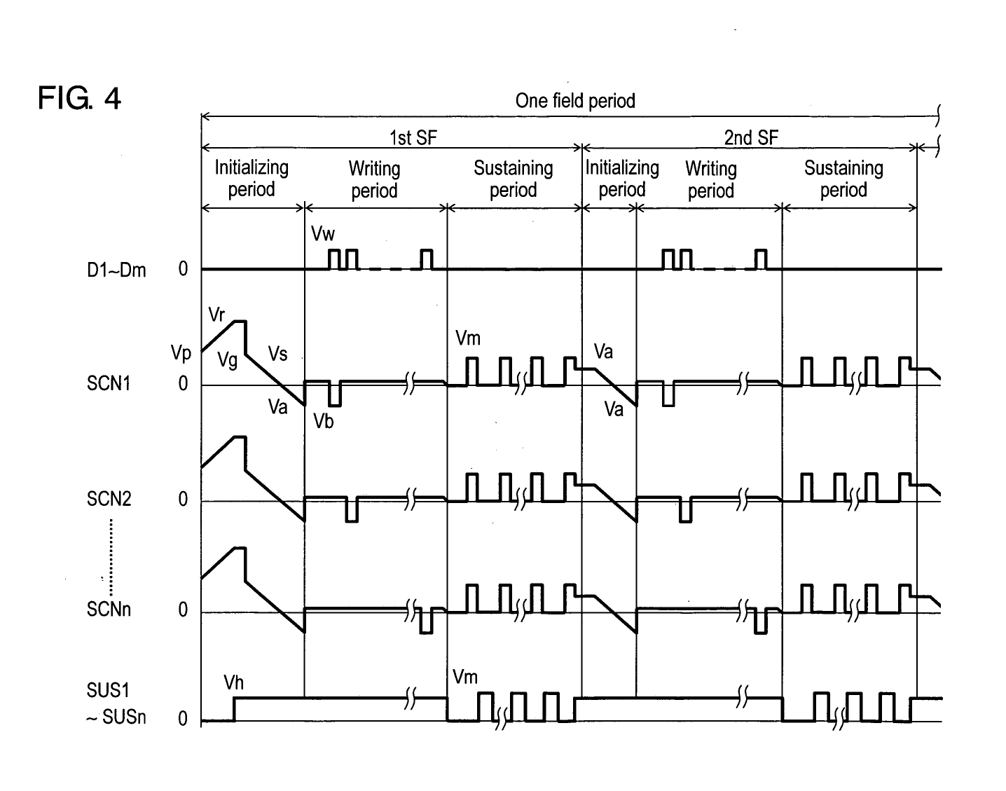

FIG. 4 is a diagram showing driving waveforms to be applied to the respective electrodes of the panel for use in the first exemplary embodiment of the present invention. In this embodiment, the initializing operation in the 1st SF is all-cell initializing operation, and the initializing operation in the 2nd SF is selective initializing operation.

In the initializing period in the 1st SF, while data electrodes D1 to Dm and sustaining electrodes SUS1 to SUSn are kept to 0(V), a ramp voltage gradually increasing from voltage Vp (V) up to a discharge-starting voltage to voltage Vr (V) exceeding the discharge-starting voltage is applied to scan electrodes SCN1 to SCNn. This application causes first weak initializing discharge in all the discharge cells, accumulates negative wall voltage on scan electrodes SCN1 to SCNn and positive wall voltage on sustain electrodes SUS1 to SUSn and data electrodes D1 to Dm. Now, the wall voltage on the electrodes indicates the voltage generated by wall electric charge accumulating on the dielectric layer or phosphor layers covering the electrodes.

Thereafter, sustain electrodes SUS1 to SUSn are kept at positive voltage Vh (V), and a ramp voltage gradually decreasing from voltage Vg (V) to voltage Va (V) is applied to scan electrodes SCN1 to SCNn. This application causes second weak initializing discharge in all the discharge cells, weakens the wall voltage on scan electrodes SCN1 to SCNn and sustain electrodes SUS1 to SUSn, and adjusts the wall voltage on data electrodes D1 to Dm to a value appropriate for writing operation.

In this manner, in the all-cell initializing operation, initializing discharge is caused in all the discharge cells to generate priming.

In the subsequent writing period, scan electrodes SCN1 to SCNn are held at voltage Vs (V) once. Next, positive write pulse voltage Vw (V) is applied to data electrode Dk (k=1 to m) of a discharge cell to be lit in the first row among data electrodes D1 to Dm, and negative scan pulse voltage Vb (V) is applied to scan electrode SCN1 in the first row. Then, a voltage amounting to the sum of the write pulse voltage and scan pulse voltage, i.e. Vw+Vb (V), is applied across scan electrode SCN1 and data electrode Dk, thus exceeding the discharge-starting voltage. This application causes discharge at the intersection of scan electrode SCN1 and data electrode Dk, and develops discharge between scan electrode SCN1 and sustain electrode SUS1 in the corresponding cell. Thus, wall charge necessary for subsequent sustaining discharge accumulates. In this manner, writing charge is completed in the discharge cell in the first row to which write pulse voltage Vw (V) is applied. On the other hand, in the discharge cells to which write pulse voltage Vw (V) is not applied, no writing discharge occurs and thus no wall charge accumulates. At this time, positive write pulse voltage Vw (V) is applied to data electrode Dk in the discharge cell in the second row or after. However, in the second row or after, no negative scan pulse voltage Vb (V) is applied to the corresponding scan electrodes, and thus the voltage applied across the scan electrode and data electrode Dk is write pulse voltage Vw (V) only. For this reason, the voltage of the cells in the second row or after does not exceed the discharge-starting voltage and causes no writing discharge.

Next, positive write pulse voltage Vw (V) is applied to data electrode Dk of a discharge cell to be lit in the second row, and negative scan pulse voltage Vb (V) is applied to scan electrode SCN2 in the second row. Then, a voltage amounting to the sum of the write pulse voltage and scan pulse voltage, i.e. Vw+Vb (V), is applied across scan electrode SCN2 and data electrode Dk, thus exceeding the discharge-starting voltage. This application causes writing discharge in the discharge cell in the second row to which write pulse voltage Vw (V) is applied. On the other hand, in the discharge cells to which write pulse voltage Vw (V) is not applied, no writing discharge occurs and thus no wall charge accumulates. Also at this time, the voltage applied across the scan electrodes and data electrode Dk in the discharge cells in the 3rd row or after is write pulse voltage Vw (V) only. For this reason, the voltage of the cells in the 3rd row or after does not exceed the discharge-starting voltage and causes no writing discharge.

Such writing operation is sequentially performed on the discharge cells in the 3rd row to n-th row, and the writing period is completed.

In the subsequent sustaining period, first, sustain electrodes SUS1 to SUSn are reset to 0V, and positive sustain pulse voltage Vm (V) is applied to scan electrodes SCN1 to SCNn. At this time, in the discharge cells in which writing discharge has occurred, a voltage generated by wall charge is added to sustain pulse voltage Vm (V), and thus exceeds the discharge-starting voltage and causes sustaining discharge. Then, wall charge having the reverse polarity accumulates in the discharge cells. Next, resetting scan electrodes SCN1 to SCNn to 0 (V) and applying positive sustain pulse voltage Vm (V) to sustain electrodes SUS1 to SUSn causes sustaining discharge in the discharge cells and reverses the polarity of the wall charge. Alternately applying the sustain pulses to scan electrodes SCN1 to SCNn and sustain electrodes SUS1 to SUSn in the similar manner continues sustaining discharge in the discharge cells in which writing discharge has occurred in the writing period.

In the initializing period in the 2nd SF, while sustain electrodes SUS1 to SUSn are kept at Vh (V) and data electrodes D1 to Dm at 0(V), a ramp voltage decreasing to voltage Va (V) is applied to scan electrodes SCN1 to SCNn. Then, in the discharge cells in which sustaining discharge has occurred in the sustaining period in the preceding subfield, weak initializing discharge occurs and forms wall charge necessary for the subsequent writing operation. On the other hand, in the discharge cells in which no writing discharge or sustaining discharge has occurred in the preceding subfield, no discharge occurs, and the wall charge at the completion of the initializing period in the preceding subfield is kept.

In this manner, for the selective initializing operation, initializing discharge occurs in the discharge cells in which sustaining discharge has occurred in the preceding subfield, and thus no priming is generated in the discharge cells in which no sustaining discharge has occurred.

The operation performed in the writing period in the 2nd SF is the same as that of the writing period in the 1st SF. Even though the brightness weight in the sustaining period in the 2nd SF is different from that in the 1st SF, otherwise the brightness weight is the same as that in the writing period in the 1st SF. Also in the SFs after the 3rd SF, as described above, the all-cell initializing operation or selective initializing operation is performed in the initializing period, the writing operation is performed in the writing period, and the sustaining operation is performed in the sustaining period. Thus, the descriptions thereof are omitted.

Next, a description is provided of a structure of subfields in the driving method of the first exemplary embodiment. As described above, in this embodiment, one field is divided into 12 subfields. However, in the present invention, the number of subfields or the brightness weight of each subfield is not limited to the above values.

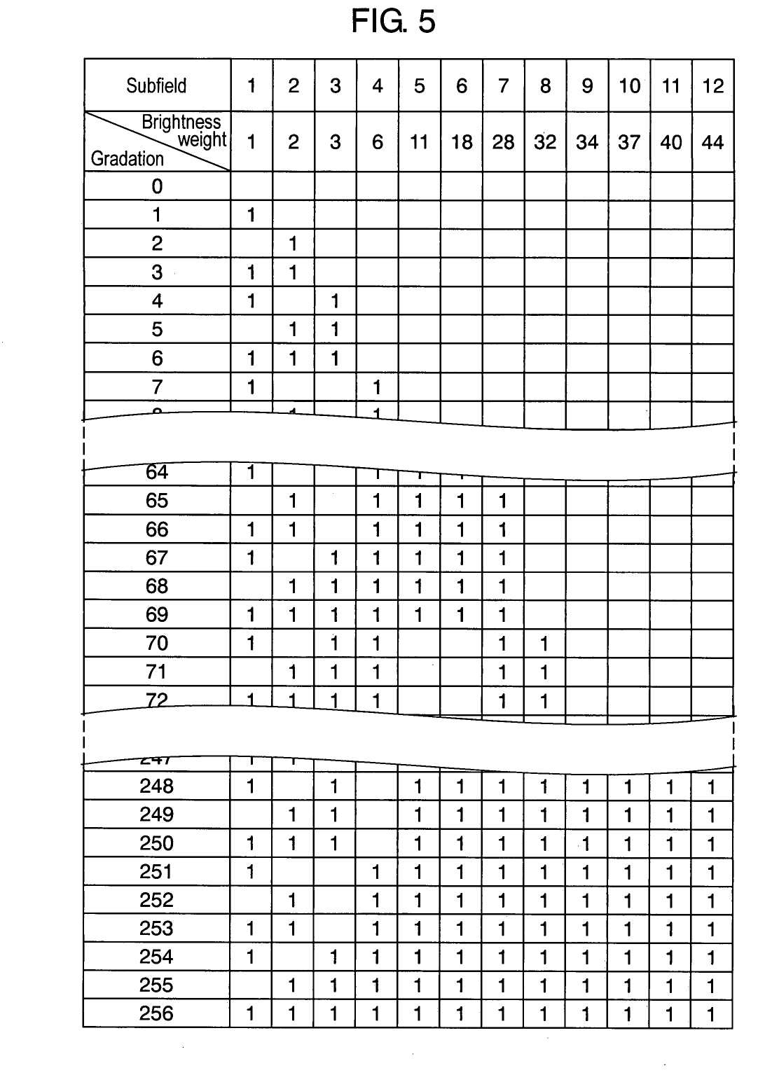

FIG. 5 is a table showing display gradations and combinations of SFs to be lit to display the gradations, i.e. so-called coding, in accordance with the first exemplary embodiment. Now, “1” indicates that the SF is to be lit, and a blank column indicates that the SF is not to be lit. The coding of the first exemplary embodiment is characterized in that SFs to be lit and those not to be lit are randomly determined in the 1st to 6th SFs, according to the gradations to be displayed. Hereinafter, such a method of displaying gradations is referred to as random coding. In the 7th to 12th SFs, writing discharge is controlled so that no sustaining discharge occurs in the SF subsequent to a SF causing no sustaining discharge. Therefore, SFs to be lit and those not to be lit are determined so that there are successive SFs to be lit with the 7th SF at the top thereof. Hereinafter, such a method of displaying gradations is referred to as successive coding. Displaying gradations using the successive coding has an advantage of causing no so-called dynamic false contours. On the other hand, this displaying method also has a disadvantage of considerably limiting the number of gradations that can be displayed. In the first embodiment, to offset such a disadvantage of the successive coding, twelve SFs comprising one field are divided into two SF groups. For gradation display, the SF group having larger brightness weights (7th to 12th SFs) uses the successive coding, and the SF group having smaller brightness weights (1st to 6th SFs) uses the random coding to increase display gradations.

In this case, the writing periods in the SF group using the successive coding except the top one, i.e. the 8th to 12th SFs, can be set shorter. The reason is described as follows. When any one of the 8th to 12th SFs is lit, the SF preceding the any SF is always a SF to be lit. Thus, in the sustaining period in the preceding SF, sustaining discharge gives a sufficient priming effect and stabilizes the writing discharge in the subsequent SF. However, for the 7th SF, i.e. the top SF of those using the successive coding (successive-coding SF), the preceding SF is not always a light-emitting SF. For this reason, it is preferable that the all-cell initializing operation is caused in the top of the successive-coding SFs to ensure the subsequent writing operation. However, the all-cell initializing operation increases black picture levels and the time taken for driving. Then, in the present invention, the light-emitting rate of one of the successive-coding SFs is estimated and the all-cell initializing operation is caused in the top SF only when the light-emitting rate is high. In the first exemplary embodiment, the light-emitting rate of the 11th SF is estimated. When the rate is equal or higher than a threshold of 40%, the all-cell initializing operation is caused in the initializing period in the 7th SF to stabilize writing operation. When the rate is lower than a threshold of 40%, the selective initializing operation is caused in the initializing period in the 7th SF to inhibit increases in black picture level.

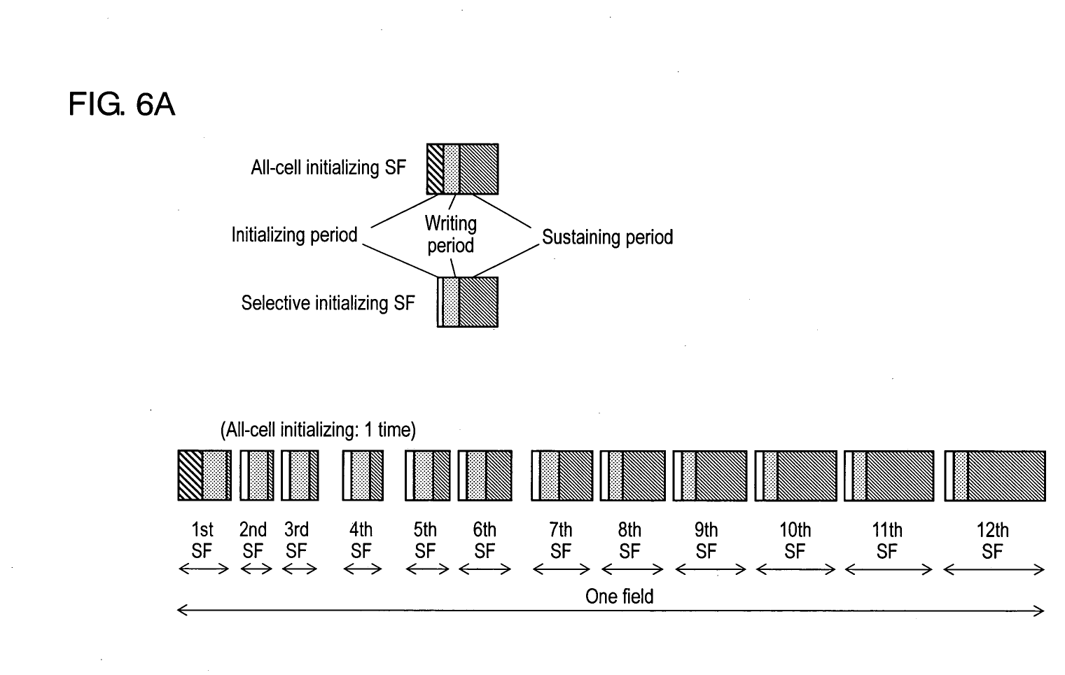

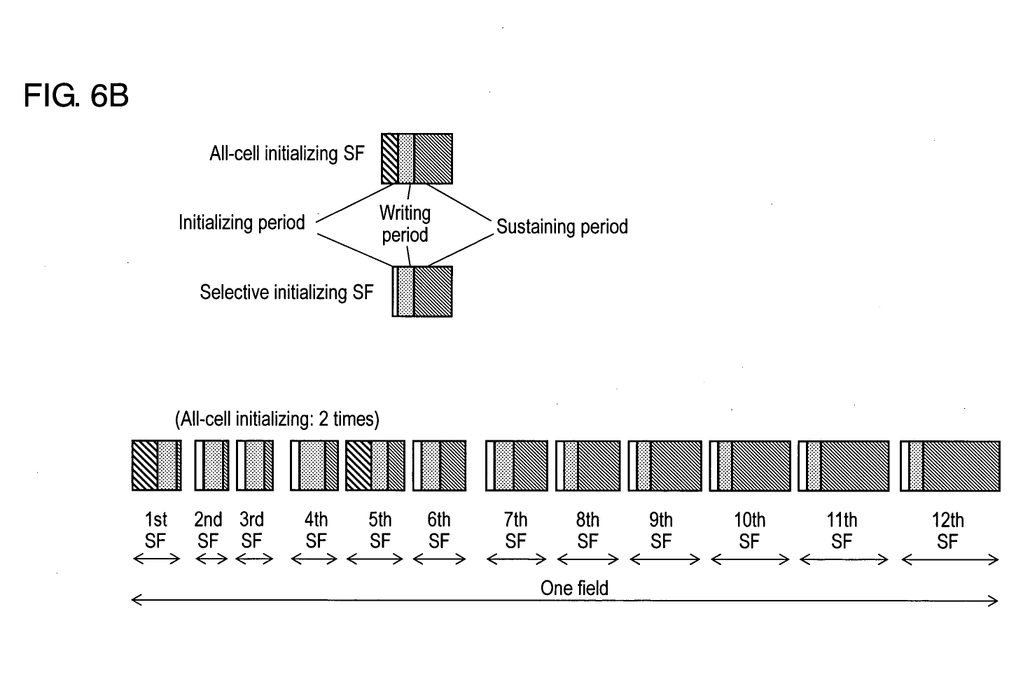

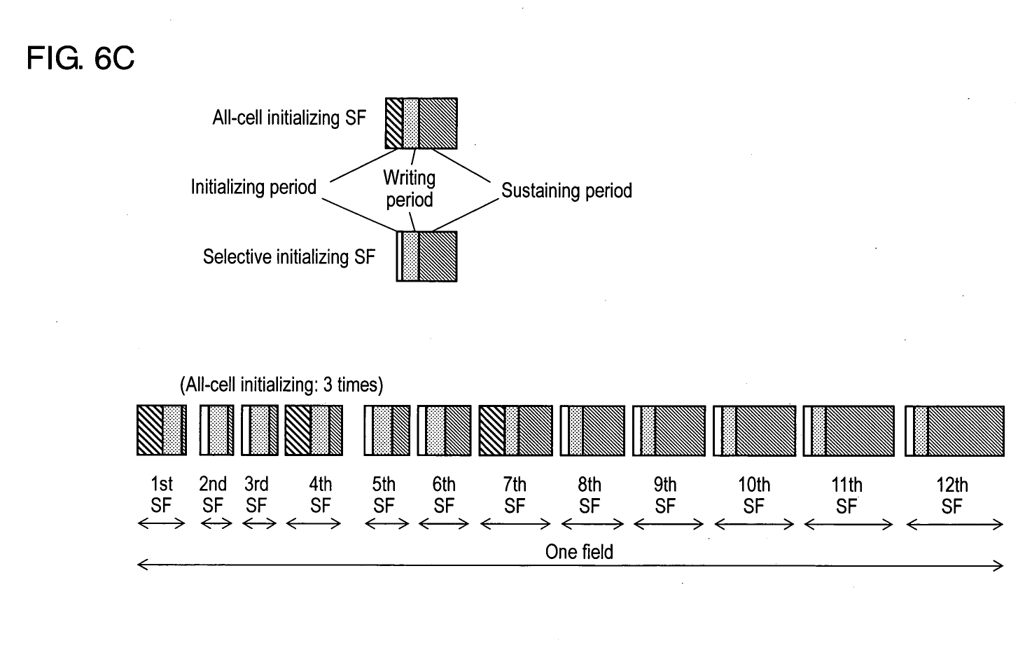

Additionally, in the first exemplary embodiment, the number of all-cell initializing operations is controlled according to the APL. FIG. 6 are diagrams, each illustrating a structure of SFs in the panel driving method of the first exemplary embodiment. The structure of SFs is changed according to the APL of an image to be displayed and the light-emitting rate of a predetermined SF. FIG. 6A shows a structure to be used when the image signal has an APL smaller than 1.5%. In this structure, the all-cell initializing operation occurs in the initializing period in the 1st SF only; the selective initializing operation occurs in the initializing periods in the 2nd to 12th SFs. FIG. 6B shows a structure to be used when the image signal has an APL of 1.5% or higher, and a light-emitting rate of the 11th SF smaller than 40%. In this SF structure, the all-cell initializing operation occurs in the initializing periods in the 1st and 5th SFs; the selective initializing operation occurs in the initializing periods in the 2nd to 4th, and 6th to 12th SFs. FIG. 6C shows a structure to be used when the image signal has an APL of 1.5% or higher and a light-emitting rate of the 11th SF of 40% or higher. In this SF structure, the initializing periods in the 1st, 4th, and 7th SFs are all-cell initializing periods; those in the 2nd, 3rd, 5th, 6th, and 8th to 12th SFs are selective initializing periods.

As described above, in the first exemplary embodiment, it is considered that there is a large area displaying a black picture in display of an image having a low APL, and thus the number of all-cell initializing operations is reduced to improve black display quality. In contrast, because it is considered that there is no or a small area displaying a black picture in display of an image having a high APL, the number of all-cell initializing operations and thus priming are increased to stabilize writing discharge. Further, the light-emitting rate of a predetermined one of the successive-coding SFs is estimated. When the rate is high, the all-cell initializing operation is caused also in the top one of the successive-coding SFs to further stabilize writing discharge. Therefore, an image having high contrast can be displayed because the area displaying a black picture has a low brightness at a low APL even though the image has areas having high brightness. When both APL and light-emitting rate are high, the all-cell initializing operation is caused in the top one of successive-coding SFs to stabilize image display.

However, when the selective initializing operation is caused in the 6th SF in display of an image having a low APL, large discharge delay can deteriorate display quality. For this reason, in the first exemplary embodiment, the writing period is set longer when the selective initializing is caused in the top one of the successive-coding SFs, and the writing period is set shorter when the all-cell initializing operation is caused therein.

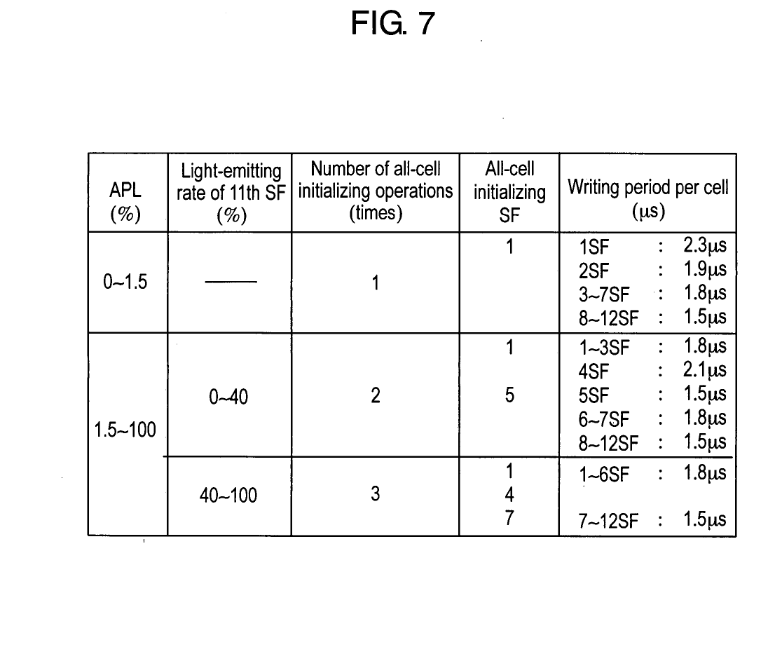

FIG. 7 is a table showing writing periods in the panel driving method in accordance with the first exemplary embodiment. When the all-cell initializing operation is performed in the initializing period in the 1st SF only in this manner, the respective writing periods per cell in the 1st to 12th SFs are set to 2.3 μs, 1.9 μs, 1.8 μs,1.8 μs,1.8 μs,1.8 μs,1.8 μs, 1.5 μs ,1.5 μs, 1.5 μs, 1.5 μs, and 1.5 μs. When the all-cell initializing operation is performed in the initializing periods in the 1st and 5th SFs, the respective writing periods per cell in the 1st to 12th SFs are set to 1.8 μs, 1.8 μs,1.8 μs, 2.1 μs,1.5 μs,1.8 μs,1.8 μs,1.5 μs,1.5 μs,1.5 μs, 1.5 μs, and 1.5 μs. When the all-cell initializing operation is performed in the initializing periods in the 1st, 4th, and 7th SFs, the respective writing periods per cell in the 1st to the 12th SFs are set to 1.8 μs, 1.8 μs,1.8 μs,1.8 μs, 1.8 μs,1.8 μs,1.5 μs,1.5 μs, 1.5 μs,1.5 μs,1.5 μs, and 1.5 μs.

Now, when the writing period in the top one of the successive-coding SFs, i.e. the 7th SF, is focused, the writing period is set to 1.5 μs, when the all-cell initializing operation is caused in the initializing period in the 7th SF, and to 1.8 μs when the selective initializing operation is caused therein. Thus, although the all-cell initializing operation is not caused in the initializing period in the top one of the successive-coding SFs and priming can be insufficient, the subsequent writing period set longer ensures writing discharge and generates stable sustaining discharge.

In the above example of the first exemplary embodiment, one field is made of 12 SFs, the number of all-cell initializing operations is controlled in the range from 1 to 3 times, and initializing of a SF nearer the top one is prioritized. However, the present invention is not limited to the above values. Additionally, in the first exemplary embodiment of the present invention, the light-emitting rate of the 11th SF is used as a predetermined SF; however, the predetermined SF is not limited to the 11th SF, or to only one SF. For example, the sum of each of the light-emitting rates of a plurality of SFs multiplied by its brightness weight.

### Second Exemplary Embodiment

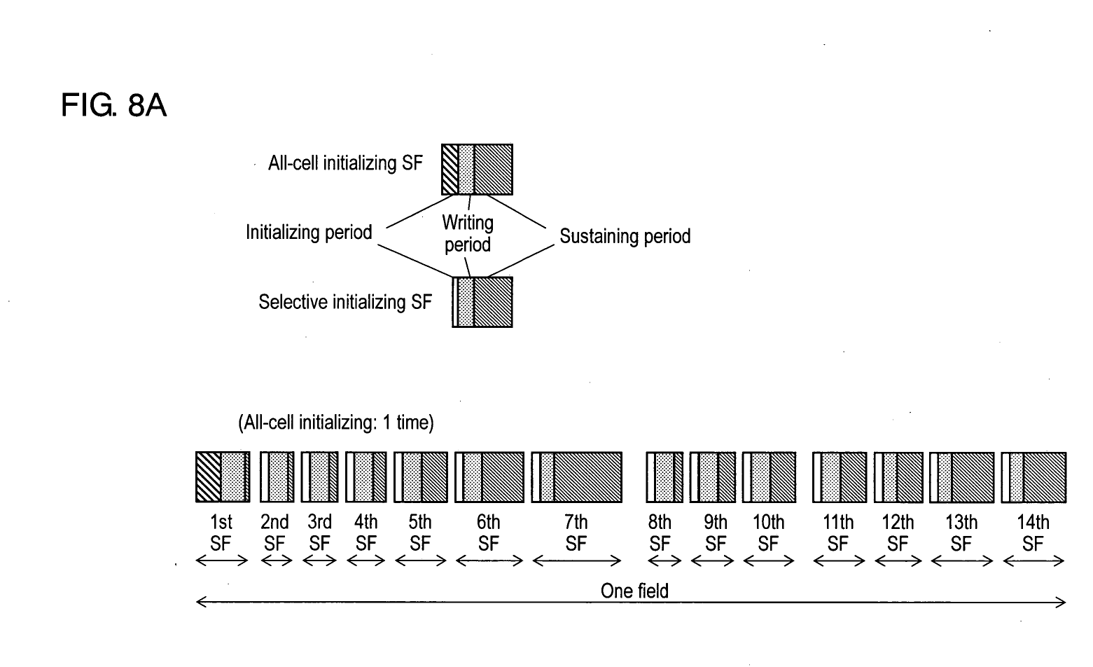

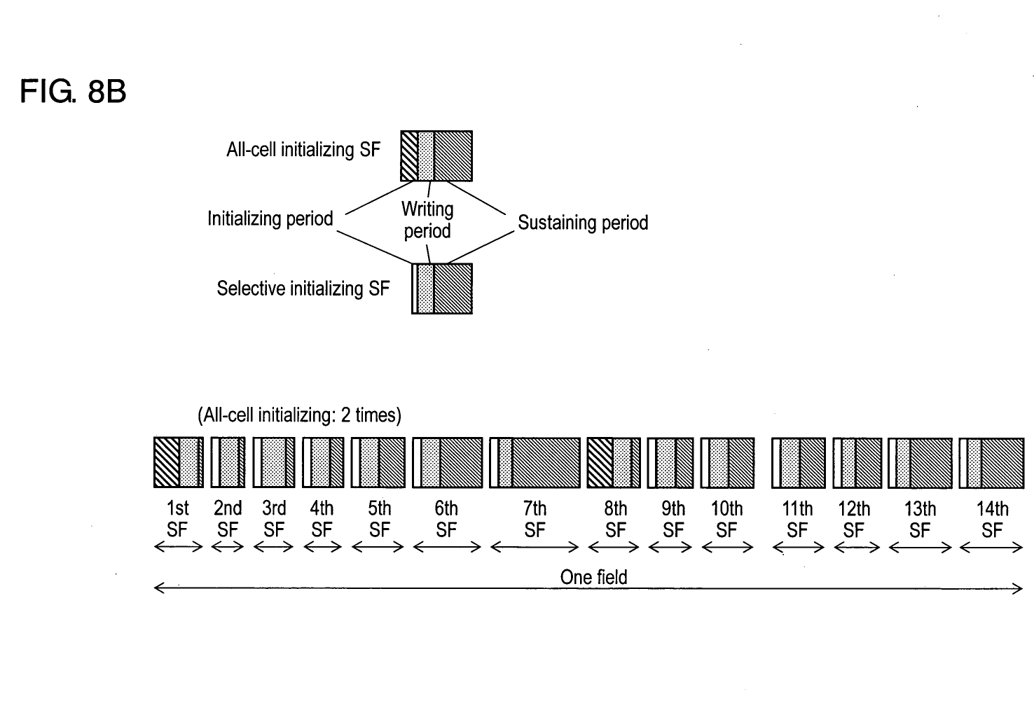

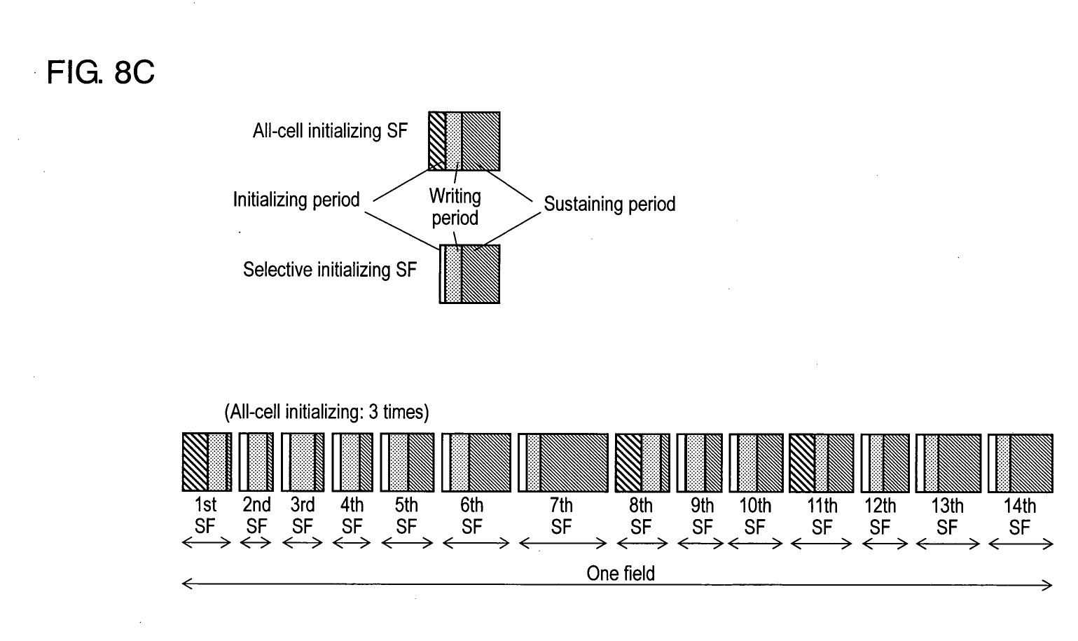

The structures of a panel and a plasma display panel device for use in the second exemplary embodiment are the same as those of the first exemplary embodiment. Difference of the second embodiment from the first embodiment is the subfield (SF) structure. FIG. 8 show diagrams, each illustrating a SF structure in accordance with the second exemplary embodiment. For the second exemplary embodiment, one field is divided into 14 subfields (SF1 to SF14), and each of the subfields has a brightness weight of 1, 2, 4, 8, 20, 32, 56, 4, 12, 16, 16, 20, 32, or 32. The SF structure and coding of the second exemplary embodiment are characterized in that the brightness weight gradually increases from the 1st to 7th SFs, but decreases once in the 8th SF and gradually increases again. Such arrangement of SFs is effective in suppressing occurrence of flickers in the image signals having low field frequencies, such as image signals in accordance with the PAL system. The 1st to 5th SFs use random coding; the 6th and 7th SFs use successive coding; the 8th to 10th SFs use random coding; and the 11th to 14th SFs use successive coding for gradation display. Also in the second exemplary embodiment, the SF structure is changed depending on the APL of an image signal, and the light-emitting rate of a predetermined SF.

FIG. 8A shows a structure to be used when the image signal has an APL smaller than 1.5%. In this structure, the all-cell initializing operation occurs in the initializing period in the 1st SF only; the selective initializing operation occurs in the initializing periods in the 2nd to 14th SFs. FIG. 8B shows a structure to be used when the image signal has an APL of 1.5% or higher, and a light-emitting rate of the 13th SF smaller than 40%. In this SF structure, the all-cell initializing operation occurs in the initializing periods in the 1st and 8th SFs; the selective initializing operation occurs in the initializing periods in the 2nd to 7th, and 9th to 14th SFs. FIG. 8C shows a structure to be used when the image signal has an APL of 1.5% or higher and a light-emitting rate of the 13th SF of 40% or larger. In this SF structure, the initializing periods in the 1st, 8th, and 11th SFs are all-cell initializing periods; those in the 2nd to 7th, 9th, 10th, and 12th to 14th SFs are selective initializing periods.

As described above, also in the second exemplary embodiment, in display of an image having a low APL, the number of all-cell initializing operations is reduced to improve black display quality. In contrast, in display of an image having a high APL, the number of all-cell initializing operations and thus priming are increased to stabilize writing discharge. Also in this embodiment, the period allocated to the writing discharge when the selective initializing operation occurs in the initializing period is set longer than the period allocated to the writing discharge when the all-cell initializing operation occurs in the initializing period.

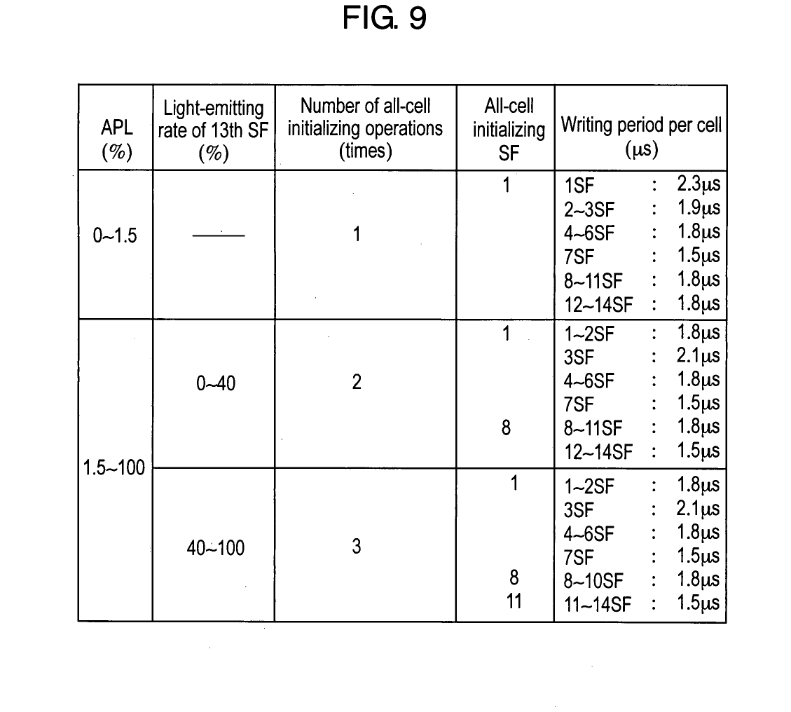

FIG. 9 is a table showing writing periods in the panel driving method in accordance with the second exemplary embodiment. Now the writing period in the top SF of the successive-coding SF group of the 11th to 14th SFs, i.e. the 11th SF, is focused. The light-emitting rate of the 13th SF is estimated. When the light-emitting rate is high, the all-cell initializing operation is also caused in the initializing period in the 11th SF to further stabilize the writing discharge. When the light-emitting rate is low, the selective initializing operation is caused in the initializing period in the 11th SF to improve contrast, and the writing period is set as long as 1.8 μs to ensure writing discharge and generate stable sustaining discharge even with insufficient priming. Therefore, at a low APL, an image having high contrast can be displayed because the area displaying black pictures has a low brightness even though the image has an area having high brightness. At a high APL and light-emitting rate, the all-cell initializing operation caused in the top one of the successive-coding SFs can provide stable image display.

### INDUSTRIAL APPLICABILITY

A panel driving method of this invention can inhibit increases in black picture level and display images at excellent quality. Thus, the present invention is useful for an image display device or the like, using a panel.

1. A plasma display panel driving method, in which one field period comprises a plurality of subfields (SFs), each of the SFs including an initializing period for generating initialing discharge in discharge cells, a writing period for generating writing discharge in the discharge cells, and a sustaining period for generating sustaining discharge to cause the discharge cells having generated the writing discharge to emit light at a predetermined brightness weight; one field period includes at least one SF group made of at least two successive ones of the SFs; in the SF group, in one of the SFs subsequent to another one of the SFs in which no sustaining discharge occurs, writing discharge is controlled to cause no sustaining discharge; the initializing discharge includes all-cell initializing operation for causing the initializing discharge in all the cells to be used to display an image, and selective initializing operation for causing the initializing discharge in all the discharge cells having generated sustaining discharge in preceding one of the SFs thereof, and in top one of the SFs in the SF group, a period allocated to the writing discharge when the selective initializing operation occurs in the initializing period is set longer than a period allocated to the writing discharge when the all-cell initializing operation occurs in the initializing period; and each of the discharge cells is formed at an intersection of scan and sustain electrodes and a data electrode, the method comprising:
determining to cause one of the all-cell initializing operation and the selective initializing operation in the initializing period in the top SF in the SF group according to a signal of an image to be displayed.

2. The plasma display panel driving method of claim 1, wherein the determining to cause the initializing operation in the initializing period in the top SF in the SF group is performed according to a light-emitting rate of a predetermined one of the SFs with respect to the signal of the image to be displayed.

3. The plasma display panel driving method of claim 1, wherein the determining to cause the initializing operation in the initializing period in each of the SFs other than those in the SF group is performed according to an average picture level (APL) of the image to be displayed.

4. A plasma display device using the plasma display panel driving method of claim 1.

5. A plasma display device using the plasma display panel driving method of claim 2.

6. A plasma display device using the plasma display panel driving method of claim 3.
